(19) United States
(12) Patent Application Publication
(10) Pub. No.: US 2005/0176833 A1
(43) Pub. Date: Aug. 11, 2005

(54) Fire resistant insulation material

(76) Inventor: Chong Hak Tay, Swiss View (SG)

Correspondence Address: NIXON PEABODY, LLP, 401 9TH STREET, NW, SUITE 900, WASHINGTON, DC, 20004-2128, US

(21) Appl. No.: 10/516,530

(22) PCT Filed: Jun. 3, 2002
(86) PCT No.: PCT/SG02/00109

(51) Int. Cl. C08J 9/00

(52) U.S. Cl. 521/50

(57) ABSTRACT

An insulation material and a method of manufacturing the insulation material are disclosed. The insulation material includes (a) particles of a combustible insulation material coated with a fire resistant material and/or (b) an open celled foam of the combustible insulation material having internal surfaces coated with the fire resistant material.

### BACKGROUND OF THE INVENTION

1. Field of the Invention

The present invention relates to an insulation material.

2. Description of Prior Art

Lightweight, rigid, homogenous, closed-cell expanded polymeric insulation materials such as expanded or extruded polystyrene foams, rigid polyurethane foam, polyisocyanurate foam and polyethylene foam are inexpensive and have been used widely as insulation in many forms, such as mouldings, boards, etc.

However, polymeric materials that are thermoplastic have a low melting point (for example, polystyrene foam) and nearly all polymeric materials have a low decomposition point compared to inorganic materials. Therefore, expanded polymeric insulation materials are generally unable to resist a fire for long, i.e. half an hour or more, as they would melt and burn and so fail early in a fire.

Open-cell and flexible expanded polymeric insulation materials have also been used as insulation materials. In addition to having the same low fire resistance of closed-cell foamed materials described above, open-cell and flexible foam materials lack rigidity. The lack of rigidity limits the use of these materials in structural applications.

A known use of polymeric insulation materials (for example, polyurethane and polyisocyanurate foams) is to cast and foam the materials between thin facings to make stressed-skin or sandwich panels. A known use of polymeric insulation materials that are not adapted for in-situ foaming (for example, expanded polystyrene or extruded polystyrene foams) is to laminate the materials to one or more thin facings to make similar stressed-skin sandwich panels. Due to their thin or lightweight components, sandwich panels are also light but have very high strength due to the stressed-skin configuration and can be used to extend across large spans of 30 m and more, with few or no intermediate supports. Sandwich panels are popularly used as walls, claddings, partitions, ceilings and roofs of buildings. Even though their surface flame spread rating follows that of the metal facing material, sandwich panels are unable to resist a fire for long, as this is dependent on the fire resistance of the core insulation material.

Another application of polymeric insulation materials, especially of expanded polystyrene foam, in the building industry is as moulded form-work elements (also known as insulating concrete formwalls) that are left in place after completing the construction of a wall or other building component as an insulation layer. Generally, form-work elements define a cavity wall inside a block of foam or between two blocks of foam secured by tie mechanisms across the cavity. The cavities are filled with concrete at intervals or in their entirety. The facing foam material is then finished with a building material in sheet form or by a lath and plaster finish. This product has a better fire resistance due to the thicker facing materials used. However, if a fire occurs and enters the insulation core, there would be the same consequences of foam melting and burning as mentioned above.

In situations in which the low fire resistance of polymeric foam insulation materials cannot be accepted, inorganic materials that are incombustible are used instead of these materials. Materials such as calcium silicate, foamed glass and mineral rock fibre slabs are able to resist a fire for a considerable length of time, e.g. 1 to 4 hours.

However, these incombustible materials usually are not as good insulators as polymeric foams and are heavy. For example, the density of foam glass is 136 kg/m³ and of mineral rock fibre is 80 to 170 kg/m³ whereas polymeric foams can be as light as 16 kg/m³. These incombustible materials are heavy and therefore difficult to handle for construction and have to be supplied in short lengths (for example, 2.4 m) and, if used in a panel, have to be in short spans or used with structural supports at close intervals. There are lightweight incombustible materials with good insulation, like fibreglass, also known as “glasswool”, but these materials do not have the strength and shear resistance for load bearing such as in a stressed-skin panel. Panels with honeycomb cores are lightweight but do not insulate well and are not fire resistant, although they do not add to a fire load if they are made of incombustible materials, e.g. metal facings and metal honeycomb core.

Some inorganic insulating materials are difficult to handle during installation and maintenance as they are brittle and break off in small pieces and cause dust contamination and, in the case of short fibre mineral wools, cause itchiness.

Aerated concrete blocks have densities from 600 to 850 kg/m³. These blocks are suitable for conventional walls but are too heavy for use as the core of a light-weight stressed-skin panel.

In the 1970s BASF introduced Styropor Beton, polystyrene foam pellets embedded in a matrix of cement. This material is highly fire resistant due to the presence of the cement matrix. The product can be poured in-situ as a flooring material. However, it has a high density of the order 500 to 600 kg/m3 and therefore is unsuitable for lightweight stressed-skin panels.

In the 1960s BASF introduced BASF HT foam, polystyrene foam pellets embedded in a matrix of siliceous inorganic binder, that formed a very hard material. This material has good fire resistance. However the high density of 155 to 165 kg/m³ would make a heavy stressed-skin panel that needs more structural support.

In U.S. Pat. No. 5,516,552 Bontrager et. al. disclose a fire resistant polystyrene board made by applying a fire resistant composition onto the surface of expanded or extruded polystyrene foam boards and impregnating the body of these boards with a sodium silicate and hydrated alumina mixture via recesses in the boards. Although this invention attempted to disperse the fire resistant composition by means of wetting agents, it is not possible to uniformly coat every section of the body of the insulation material since the coating only flows through the recesses and the interstices. Therefore, the coating is irregular and incomplete and has areas that are left uncoated and unprotected.

In 1998 the International Association of Cold Storage Contractors (IACSC), European Division, published guidelines for the construction of cold stores using insulating panels. Particular emphasis was given to the vulnerability of lightweight polymeric panels in a fire. The guidelines include suggestions to compensate for the shortcomings of lightweight polymeric panels, particularly in relation to endangering the lives of fire fighters entering a building to fight a fire.

The use of non-combustible panels was considered, but the guidelines noted that the use of lightweight polymeric panels continued to be of importance to users, manufacturers and contractors due to its low cost, proven performance and technical advantages. Consequently, a substantial portion of the guidelines deals with designs of joints and supports of lightweight polymeric panels to prevent early collapse of the panels in a fire.

These designs were mainly in the direction of securing panel skins to prevent the skins separating and falling when the insulation materials or the glue had been destroyed by fire and applying intumescent sealant to retard the penetration of fire at the joints between panels. However, although the measures made the panels safer to use by preventing the delaminated panel skins from falling and the joints from opening in a fire, none of these measures increase the fire resistance of the panels.

The guidelines were the outcome of contributions of manufacturers, contractors, industry users and fire authorities and therefore represent the practical state of the art at that time.

In subsequent reviews by the IACSC in 2000 and 2001 and in additional publications by the IFPO and the British Home Office it can be seen that, while fire fighters appreciated and approved the added safety measures, insurers were not satisfied with the poor fire resistance of panels made with polymeric insulation materials, as buildings using these materials were usually badly damaged in fires. In order to press the point, insurers described such buildings as buildings “on fire” and not buildings “in a fire”. The insurers pressed for the use of panels with incombustible cores. Industry users, manufacturers and contractors however were disinclined to adopt that measure due to the higher cost of panels with incombustible and heavy cores and technical problems known to be associated with their use. Technical problems include by way of example extensive moisture damage should the vapour barrier of a panel with mineral fibre insulation be breached and the ease of damage from foot traffic when it is used as a ceiling.

Although the problems enumerated by the IACSC specifically applied to the cold storage industry, the problems are equally applicable in other situations where insulating panels are used to maintain a temperature and humidity zone, for example, in clean rooms, wall claddings, partitions, ceiling and roofs for factories.

The guidelines of the IACSC recognise the problems associated with the use of polymeric insulation materials in panels. However, the tone and context of the follow-up reviews and other independent publications by fire authorities highlight an urgent need to find solutions to these problems if polymeric insulation materials are to be continued to be used in panels.

### SUMMARY OF THE INVENTION

According to the present invention there is provided an insulation material that includes (a) particles of a combustible insulation material coated with a fire resistant material and/or (b) an open celled foam of the combustible insulation material having internal surfaces coated with the fire resistant material.

The term “particles” is understood herein to include pellets.

The particles may be a regular shape or an irregular shape.

Regular shape particles include, by way of example, spherical and rod-like shape particles.

Preferably a major dimension of the particles is less than 25 mm.

More preferably the major dimension of the particles is less than 20 mm.

It is preferred particularly that the major dimension of the particles be 2-15 mm.

Preferably the insulation material includes coated particles bonded together by a binder material.

Preferably the binder material at least substantially fills the interstices between coated particles.

The binder material may be the coating material.

Preferably the particles are at least substantially encapsulated by the fire resistant material.

Preferably the particles also include a fire retardant material.

The combustible insulation material may be any suitable material.

For example, the combustible insulation material may be a suitable polymeric material.

Preferably the particles of combustible insulation material are pre-foamed pellets of a polymeric material, such as polystyrene of a fire retardant grade.

The particles may also be obtained by way of example by grinding and recycling formed products, such as foamed polymeric products, for example, expanded polystyrene foam from building boards, recovered panels, packaging, foam containers, extruded polystyrene foam, polyurethane foam, phenolic foam, etc.

Many other materials can also be used as the source of the particles, including natural materials e.g. cork granules, wood chips, rice husks, etc.

Preferably the coating of the fire resistant material is applied to the particles at a thickness corresponding to the degree of fire resistance that is desired.

Preferably the combustible insulation material for the open cell foam is polyimide foam or melamine foam.

The fire resistant coating material is preferably an intumescent material, such as FX-100, Albi Cote FRL, NoFire A-18, or a mixture of fire resistant materials.

By way of example, the fire resistant coating material may include aluminium trihydrate, a char promoter (such as Chlorez and Holdaresin), a carbon donor (such as dipentaerytritol), an acid donor (such as ammonium polyphosphate), a propellant (such as melamine), a binder (such as polyvinyl acetate and polyvinyl ester), an exfoliating graphite, hydrated alkali metal silicates (such as sodium silicate), a silicate insolubiliser (such as sodium fluorosilicate), and a surfactant.

Preferably the intumescent coating material is selected according to the properties desired, such as the temperature of activation, stiffness of the intumescence, and the pressure generated during expansion. Generally, a lower initiation temperature, greater stiffness and lower expansion pressure is preferred.

According to the present invention there is also provided a method of manufacturing an insulation material that includes coating particles of combustible insulation material with a fire resistant material.

Preferably the method includes coating the particles so that the particles are at least substantially encapsulated with the fire resistant material.

Preferably the particles also include a fire retardant material.

The method may include forming free-flowing loose-fill agglomerates of the coated particles.

Preferably the method includes forming free-flowing loose fill agglomerates of the coated particles by mixing the coated particles with a binder material that sets to hold the particles together.

The method may also include forming panels or other shaped products from the coated particles that may be used, for instance, in building construction or as building construction elements.

Preferably the method includes forming panels or other shaped products by mixing the coated particles with a binder material.

Preferably the binder material at least substantially fills the interstices between coated particles in the products.

The binder material may be the coating material.

Preferably the method includes coating particles of combustible insulation material with the fire resistant material by forming a coating of the fire resistant material on the particles and thereafter curing the fire resistant material.

Preferably the curing temperature is below the service temperature of the combustible insulation material, particularly in situations in which the combustible insulation material is a polymeric material.

In situations in which the fire resistant material includes an intumescent material, preferably the curing temperature is below the activation temperature of the intumescent material.

Typically, the curing temperature is 50-70° C. in situations in which the combustible insulation material is a polymeric material and the fire resistant material includes an intumescent material. The service temperatures of preferred polymeric materials are 80-300° C. The activation temperatures of preferred intumescent materials are 100-260° C. The activation temperatures of particularly preferred intumescent materials are 100-200° C.

The step of coating the particles with the fire resistant material so that the particles are at least substantially encapsulated in the fire resistant material in effect encases each particle in a fire resistant cocoon. Even if the particles are made of a combustible insulation material such as a thermoplastic material that melts in a fire, the encapsulation of the particles contains and retards the release of the combustible melt and thereby reduces the rate the fire develops and spreads. Further the cocoon retards the release of sooty and toxic combustion by-products.

If a fire retardant material has been incorporated into the particles, the encapsulation of the particles retains the gases released when the fire retardant material is activated by a fire and thereby enhance the smothering effect of the fire retardant.

Preferably the insulation material includes a uniform distribution of coated particles, whereby the insulation material can resist a fire coming from any direction.

Further, a uniform distribution of coated particles allows the insulation material to be freely cut and reshaped after manufacture without reducing the degree of fire protection.

The insulation material when used directly (as agglomerated particles) or indirectly (i.e. in a formed shape) can also be bonded to one or more sides of thin metal facings or non-metal facings to make an insulating panel. Even if the particles chosen for the insulation material are combustible, the insulating panel made from the insulation material would have a degree of fire resistance not found in the original, uncoated particles. Such a panel is a solution to the concerns of agencies such as the IACSC that panels made from polymeric insulation materials burn rapidly and make a significant contribution to a fire.

The method may include manufacturing the insulation material from particles having a range of different particle sizes.

The method may include manufacturing the insulation material by coating the particles with a range of different coating thicknesses.

The method may include manufacturing the insulation material with layers of different sized particles and/or different coating thicknesses, for example, so that the insulation and fire resistance properties of the insulation material varies through its cross section.

For example, the insulation material may have smaller particles with a thicker fire resistant coating located near the surface of the material, where a fire can be expected to impinge on it, and larger particles with a thinner coating located in the interior where more insulation and less fire protection is required.

The above-described means make it possible to engineer or to optimise the use of materials to make the insulation material stronger near the surfaces and, if used in a sandwich panel, to give it a greater load carrying capacity. Likewise, the degree of fire protection can be engineered or optimised by having more of the fire resistant material elements of the panels, i.e. the type of particles, size, fire resistant coating and binder, disposed near the surfaces where a fire is most likely to be encountered.

The method may include manufacturing the insulation material from particles of several different insulation materials, whereby the properties and cost of the insulation material can be controlled in ways that are not possible with an article made of a homogenous material. An example of such an insulation material is one in which combustible insulation materials are combined with incombustible insulation materials.

By way of particular example, one such insulation material includes an outermost layer of an incombustible insulation material such as perlite or vermiculite to enhance the fire resistance of the insulation material, the degree of which can be varied by changing the thickness of the incombustible layer.

In another example, the cost can be reduced by the use of lighter particles towards the centre of an insulation material as at this point the tensile and compressive forces are less and do not require a strong material.

Another example of how cost can be lowered is the use of particles of recycled insulation materials. In the prior art, recycled materials cannot be mixed into a fresh rigid polyurethane foam mixture and there is a limit to the amount of recycled material that can be mixed with fresh polystyrene foam material. However, in this invention, all of the particles can be recycled insulation materials.

The coating materials for the particles and/or the binder materials that bind the particles together may have water-proofing and/or vapor-proofing properties so that the insulation material has water and/or vapor resistance. It is known that particles of combustible insulation materials tend to permit some transmission of water vapour and, depending on the material, may also absorb water. In this invention, the coating materials and the binder material contribute to resisting vapor and water ingress. This is important as insulation materials are frequently used in situations that are exposed to moisture condensation or water ingress. Even when such insulation materials include metal facings, the joint seals may fail or may not be present, whereby moisture and water ingress will quickly destroy the insulation property of the panel. This invention is a means of substantially nullifying such moisture and water ingress.

The insulation material may make it possible to include mechanically weak materials in a structural panel, for example, phenolic foam, which have good fire resistance but are unsuitable to be used as a structural panel because the materials are friable and easily delaminate when mechanically stressed. In this invention such weak materials can be used in a panel if they are reduced to particles and encapsulated. By this means, the weakness of material is isolated and is also substantially compensated by the extensive matrix of coatings/binders that provide cohesion and mechanical strength.

The coating material and/or the binder material of the insulation material may include fibre reinforcement that improves the mechanical properties of the insulation material. For example, polypropylene fibres provide stronger mechanical strength, particularly in shear and tension, and glass or ceramic fibres, such as Nomex fibres or Kevlar fibres, or mineral fibres enhance fire resistance and mechanical strength.

According to the present invention there is also provided a method of manufacturing an insulation material that includes coating an open celled foam of a combustible insulation material with a material that is fire resistant and contributes to the rigidity of the insulation material.

Preferably the method includes coating the open celled foam with the fire resistant material by forming a coating of the fire resistant material on the open celled foam and thereafter curing the fire resistant material.

Preferably the curing temperature is below the service temperature of the combustible insulation material, particularly in situations in which the combustible insulation material is a polymeric material.

In situations in which the fire resistant material includes an intumescent material, preferably the curing temperature is below the activation temperature of the intumescent material.

Typically, the curing temperature is 50-70° C. in situations in which the combustible insulation material is a polymeric material and the fire resistant material includes an intumescent material. The service temperatures of preferred polymeric materials are 80-300° C. The activation temperatures of preferred intumescent materials are 100-260° C. The activation temperatures of particularly preferred intumescent materials are 100-200° C.

Preferably the method includes coating the open celled foam by impregnating the foam with the fire resistant material.

The open celled foam may be readily impregnated by any suitable method. By way of example, the open celled foam may be readily impregnated by using a solution, a gel, or a dispersion of the fire resistant material and immersing, spraying, pouring, or otherwise contacting the material with the open celled foam, thereafter removing excess material by squeezing, draining, or spinning actions, and thereafter drying/curing the coating. This method may be repeated as required to build up the thickness of the coating.

The open cell foam structure may be manufactured by any suitable means.

Preferably the insulation material is suitable for structural applications.

Preferably the fire resistant material is selected so that the insulation material has sufficient rigidity for structural applications.

Preferably the fire resistant material is sodium silicate or an intumescent material.

The combustible insulation material may be any suitable material.

Examples of suitable combustible insulation materials include polyimide foam and melamine foam.

The applicant has found in experimental work that melamine foam is a particularly suitable combustible insulation material.

The melamine foam tested by the applicant was a flexible material with open cells. The foam structure comprised a network of interconnected rods. Usually, such a flexible material would not be suitable for structural applications.

The applicant impregnated the melamine foam with sodium silicate solution and/or intumescent fire resistant coating material. The impregnated melamine foam had considerably improved rigidity and fire resistance.

According to the present invention there is provided a product that includes the above-described insulation material.

### DESCRIPTION OF THE DRAWINGS

FIGS. 1 to 13 are side elevations of preferred embodiments of insulation materials in accordance with the present invention.

### DESCRIPTION OF THE PREFERRED EMBODIMENTS

Each of the preferred embodiments of the insulation material illustrated in the figures includes particles of a combustible insulation material that are coated with a fire resistant material.

The insulation material may be in the form of loose-fill, i.e. free flowing, agglomerates of coated particles and a binder material.

The insulation material may also be shaped products of the insulation material. The shaped products, of regular or irregular shape, may be formed by way of example from the above-described particles and/or agglomerates.

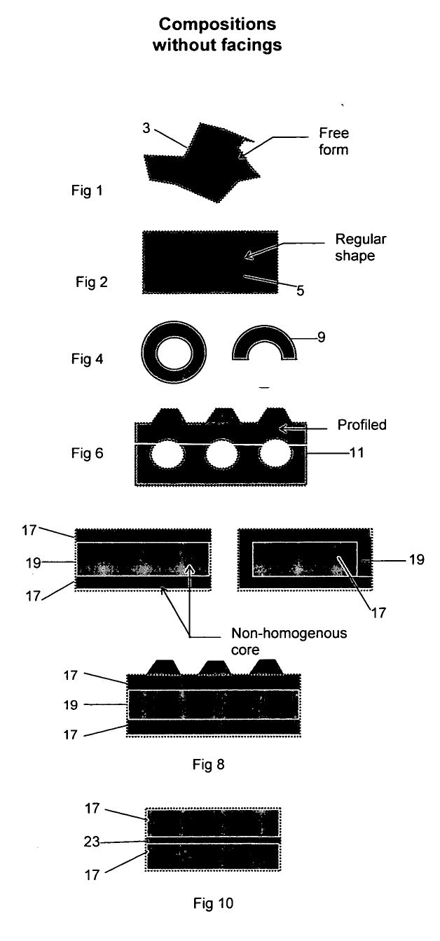

(a) FIG. 1 illustrates one embodiment of a product that includes coated particles and binder material that are form on a free-form basis an agglomerate 3 of the coated particles and binder material in the shape shown in the figure. The agglomerate can be cut, shaped, drilled and generally handled like conventional building materials.

(b) FIGS. 2, 4 and 6 illustrate embodiments in which the coated particles and binder material are formed into products such as boards 5, cylinders 7, curved elements 9, or any other profiled shapes 11. The products can be cut, shaped, drilled and fixed and generally handled like conventional building material.

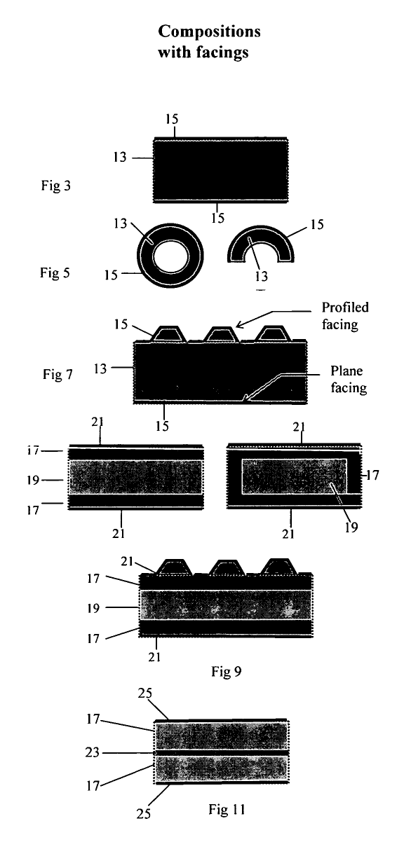

(c) FIGS. 3, 5 and 7 illustrate embodiments of products that include a core 13 of coated particles and binder material and a layer 15 of facing materials such as sheet metal on one or more exposed surfaces of the core. These products, namely stressed-skin or sandwich panels for engineering or construction use, may be manufactured by casting coated particles and binder into a cavity between separated facing sheets that are kept apart in a jig. The facing sheets can be flat, curved or profiled steel, aluminium or stainless steel, etc, or the facing sheets may be non-metal facings such as fibreglass, fiber-reinforced cement or calcium silicate, etc. The binder material is chosen to react chemically, for example, one-component moisture-cured polyurethane, or a 2-component polyurethane foam. These products may also be manufactured by adhering thin facing sheets to the products shown in FIGS. 2, 4 and 6 respectively. The facing sheets can be metal, such as unpainted or painted galvanized steel, aluminium or stainless steel, etc, or the facing sheets may be non-metal facings such as fibreglass, fiber-reinforced cement or calcium silicate, etc.

(d) FIG. 8 illustrates an embodiment of products that include non-homogenous cores formed from series of layers 17, 19 of coated particles of different sizes and/or density and/or type of combustible insulation material and binder. For example, the layers 17 nearer the surfaces can be filled with particles that are smaller and/or the particles can have a thicker coating of intumescent material or a coating having other desired properties. In the centre of the embodiment the particles may be larger and/or have thinner coatings. These centrally placed particles may be all of one size or alternatively may be progressively larger and/or with progressively thinner coatings towards the surfaces. In yet another possibility of this non-homogenous embodiment, incombustible particles, such as, perlite or vermiculite and/or with a more fire-resistant coating, for instance, can be placed beneath the surfaces, to further enhance the resistance to a fire. In yet another possibility, hollow microspheres of glass or ceramic can be incorporated in the binder material as a filler to reduce the interstices between particulates and thereby improve the insulation and also the fire resistance. In yet another possibility, expandable graphite particles, which when exposed to high temperatures intumesce to form a heat barrier, can be incorporated in the binder material to further improve the fire resistance.

(e) FIG. 9 illustrates an embodiment of products that include non-homogenous cores formed from a series of layers 17, 19 of coated particles of different sizes and or density and or type of combustible insulation material and binder material and one or more layers 21 of facing materials such as sheet metal on one or more exposed surfaces of the cores. The product may include the features of the FIG. 8 product described in sub-paragraph (d) above. In addition, hollow microspheres of glass or ceramic can be incorporated into an adhesive layer that secures the facings to the core to improve the fire resistance at these boundaries. Furthermore, expandable graphite particles can be incorporated into the adhesive layer that secures the facings to the core to improve the fire resistance at these boundaries. In yet another possibility, this arrangement can also include stronger, load bearing particles, for example, of extruded polystyrene foam, beneath the facings to resist compressive buckling of the panels.

(f) In another embodiment, there may be non-combustible insulation materials. While these materials do not need additional fire resistance provided by a coating of a fire resistant material, the materials can benefit from other properties that can be provided by a coating, such as, water-proofness or vapour-proofness. Being able to resist condensation and moisture ingress, preserves the insulating property of the particles.

(g) FIGS. 10 and 11 illustrate embodiments of products that are in the form of a board or panel that include a layer 23 or layers 23 (not shown) of material of heavier mass than the coated particles of incombustible insulation material and binder material that form other layers 17 of the product. The product shown in FIG. 11 also has outer layers 25 of facing materials. The material may be thin lead sheet or lead-filled sound dampener sheet that acts as a sound transmission barrier. The preferred arrangement is for the heavy sheet to be located in the centre of the article.

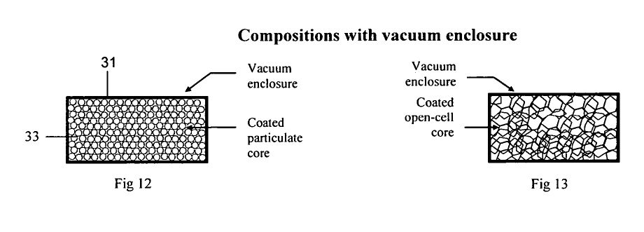

(h) FIGS. 12 and 13 illustrate embodiments of products that are in the form of vacuum insulation panels that include outer skins 31 of thin gas barrier material and inner cores 33 of coated particles (FIG. 12) or an open cell structure coated with fire resistant material (FIG. 13). The products have rigid, porous and fire resistant cores which allows the rapid evacuation of air. The light weight rigid particles or rigid reinforced cell networks are capable of withstanding the vacuum pressure without collapse. The products may be in any suitable shape. In particular, the use of the above-described cores 33 makes it possible to manufacture shaped forms, such as container assemblies, and then apply suitable outer skins to the shaped cores 33.

Examples of use (or Preferred Methods of Manufacture)

Application and Uses for the Present Invention

In one method the particles are first coated with a liquid fire-resistant material. There are many coating options, for example, stirring or tumbling a mixture of the two, spraying the coating onto the particles, spraying the coating onto the particles in a fluidised bed, percolation, immersion, or by any other means that can coat the particles thoroughly.

Following this, the coated particles are poured into a single charge mould. More of the coating material is introduced to fill the interstices and to bind the coated particles to each other. The coating/binder is set and dried in a number of ways, for example, by externally applied heat or dielectric or radio-frequency heating or hot air passing through the mix. The mould is envisaged to have a lid for charging the mix into it and with sides that can be opened so that product can be taken out. It is also envisaged that the contents of the mould be partially compressed by one of the sides moving in to reduce the mould volume after it is closed, to induce a better contact between the particles and to reduce the voids that are between them.

In another method, the coated particles are dried before they are charged into a mould. In this instance the same intumescent coating or different fire-resistant material may be selected as the binder, for example, to provide a greater stiffness or a greater flexibility of the matrix as is desired. The binding coating need not be an intumescent material, although this is the preferred material. After this, the mix is processed as described in the preceding paragraph.

In another method, the coated particles are dried before they are charged into a mould. In this instance, a polyurethane or polyisocyanurate foamable mix is introduced into the mould as a filler and binder. These materials are formulated to react, foam and polymerize rapidly, to fill the interstices and bind the particulates. However as these filler/binder materials are combustible, the particles are pre-coated to a greater thickness in order to compensate for the extra combustible material load in the interstices that has to be protected.

In another method, the mould can have a continuous feed end and a continuous discharge end. Fresh material is introduced at one end and cured material is continuously extruded from the opposite end, pushed by the pressure of the incoming fresh material. The coating/binding material is set and dried in a number of ways, for example, by externally applied heat or by dielectric or radio-frequency heating or by hot air passing through the mix as the material traverses the length of this moulding station.

Many modifications may be made to the preferred embodiments of the present invention described above without departing from the spirit and scope of the invention.

1. An insulation material that includes at least one of (a) particles of a combustible insulation material that are coated with a fire resistant material and bonded together with a binder material and (b) an open celled foam of the combustible insulation material having internal surfaces coated with the fire resistant material.

2. The insulation material defined in claim 1 wherein the fire resistant material is an intumescent material.

3. The insulation material defined in claim 1 wherein the binder material at least substantially fills interstices between coated particles.

4. The insulation material defined in claim 3 wherein the binder material is the coating material.

5. The insulation material defined in claim 1 wherein the particles are at least substantially encapsulated by the fire resistant material.

6. The insulation material defined in claim 1 wherein the particles include a fire retardant material.

7. The insulation material defined in claim 1 wherein at least one of the coating material for the particles and the binder material that binds the particles together have at least one of water-proofing and vapor-proofing properties.

8. The insulation material defined in claim 1 wherein at least one of the coating material and the binder material include fibre reinforcement that improves the mechanical properties of the insulation material.

9. The insulation material defined in claim 1 wherein the combustible insulation material includes recycled insulation material.

10. A method of manufacturing an insulation material that includes coating particles of combustible insulation material with a fire resistant material.

11. The method defined in claim 10 further comprising coating particles of combustible insulation material with a liquid form of the fire resistant material.

12. The method defined in claim 11 further comprising includes transferring the particles with the liquid form of fire resistant material into a mould, filling the interstices with further liquid fire resistant material, and removing the insulation material from the mould after the liquid fire resistant material has dried or set to a sufficient extent.

13. The method defined in claim 11 further comprising transferring coated particles into a mould after the liquid form of the fire resistant material has dried into a solid form, filling the interstices between the particles in the mould with a liquid binder material, and removing the insulation material from the mound after the liquid binder material has dried or set to a sufficient extent.

14. The method defined in claim 11 further comprising transferring coated particles into a mould after the liquid form of the fire resistant material has dried into a solid form, filling the interstices between the particles in the mould with a polyurethane or polyisocyanurate foamable mixture, and removing the insulation from the mould after the foamable mixture has reacted and formed a foam product.

15. The method defined in claim 10 comprising forming free-flowing loose-fill agglomerates of the coated particles.

16. The method defined in claim 10 comprising forming free flowing loose-fill agglomerates of the coated particles and with a binder material that sets to hold the particles together.

17. The method defined in claim 10 comprising forming panels or other shaped products from the coated particles.

18. The method defined in claim 17 comprising forming panels or other shaped products by mixing the coated particles with a binder material.

19. The method defined in claim 18 wherein the binder material at least substantially fills interstices between coated particles in the products.

20. The method defined in claim 17 further comprising forming panels or other shaped products having a uniform distribution of coated particles, whereby the insulation material can resist a fire coming from any direction.

21. The method defined in claim 20 further comprising applying metal facings or non-metal facings to the panels or other shaped products.

22. The method defined in claim 10 further comprising manufacturing the insulation material from particles having a range of different particle sizes.

23. The method defined in claim 10 further comprising manufacturing the insulation material by coating the particles with a range of different coating thicknesses.

24. The method defined in claim 10 further comprising manufacturing the insulation material with layers at least one of different sized particles and different coating thicknesses so that the insulation and fire resistance properties of the insulation material varies through its cross section.

25. The method defined in claim 24 further comprising manufacturing the insulation material with smaller particles and a thicker fire resistant coating located near the surfaces of the material and larger particles and a thinner coating located in the interior.

26. The method defined in claim 24 further comprising forming the layers with a binder material to hold the particles together within a layer and to hold the layers together.

27. The method defined in claim 26 further comprising incorporating microspheres of glass or ceramic material in at least one of (a) the adhesive layer binding the facings to the insulation particles to improve the fire resistance at that boundary and (b) the binder material as a filler to reduce the interstices between particles and thereby improve the insulation and the fire resistance.

28. The method defined in claim 27 wherein the microspheres are hollow.

29. The method defined in claim 10 further comprising manufacturing the insulation material from particles of different insulation materials.

30. The method defined in claim 29 further comprising manufacturing the insulation material from combustible insulation materials and incombustible insulation materials.

31. A method of manufacturing an insulation material that includes coating an open celled foam of a combustible insulation material with a material that is fire resistant and contributes to the rigidity of the insulation material.

32. The method defined in claim 31 further comprising coating the open celled foam by impregnating the foam with the fire resistant material.

33. The method defined in claim 31 wherein the insulation material is suitable for structural applications.

34. The method defined in claim 31 wherein the fire resistant material is sodium silicate or an intumescent material.

35. A product that includes the insulation material defined in claim 1.
